(19) United States
(12) Patent Application Publication
(10) Pub. No.: US 2013/0307778 A1
(43) Pub. Date: Nov. 21, 2013

(54) NEAR-FIELD COMMUNICATION INPUT DEVICE INCLUDING NEAR-FIELD COMMUNICATION MOUSE PAD AND MOUSE AND RELATED METHODS

(71) Applicants: Douglas James Arthur Burrell, Waterloo (CA); David Ryan Walker, Waterloo (CA)

(72) Inventors: Douglas James Arthur Burrell, Waterloo (CA); David Ryan Walker, Waterloo (CA)

(73) Assignee: RESEARCH IN MOTION LIMITED, Waterloo (CA)

(21) Appl. No.: 13/474,978

(22) Filed: May 18, 2012

(51) Int. Cl. G06F 3/033; H04B 5/00

(52) U.S. Cl. 345/166; 345/163

(57) ABSTRACT

A near-field communication (NFC) input device may include an NFC mouse pad to be coupled to an electronic device. The NFC mouse pad may include a first NFC device. The NFC input device may further include an NFC mouse configured to generate movement data based upon movement relative to the NFC mouse pad. The NFC mouse may include a second NFC device to wirelessly communicate the movement data to the first NFC device for the electronic device.

### TECHNICAL FIELD

The present disclosure generally relates to the field of communications, and more particularly, to wireless communications systems and related methods.

### BACKGROUND

Mobile communication systems continue to grow in popularity and have become an integral part of both personal and business communications. Various mobile devices now incorporate Personal Digital Assistant (PDA) features such as calendars, address books, task lists, calculators, memo and writing programs, media players, games, etc. These multi-function devices usually allow electronic mail (email) messages to be sent and received wirelessly, as well as access the Internet via a cellular network and/or a wireless local area network (WLAN), for example.

Some mobile devices incorporate contactless card technology and/or near field communication (NFC) chips. NFC technology is commonly used for contactless short-range communications based on radio frequency identification (RFID) standards, using magnetic field induction to enable communication between electronic devices, including mobile wireless communications devices. This short-range high frequency wireless communications technology exchanges data between devices over a short distance, such as only a few centimeters.

### BRIEF DESCRIPTION OF THE DRAWINGS

FIG. 1 is a plan view of an NFC system in accordance with an example embodiment.

FIG. 2 is a schematic block diagram of the NFC system of FIG. 1.

FIG. 3 is a plan view of an NFC system in accordance with another example embodiment.

FIG. 4 is a schematic block diagram of the NFC system of FIG. 3.

FIG. 5 is a schematic block diagram illustrating additional components that may be included in the electronic device of FIG. 1.

### DETAILED DESCRIPTION

The present description is made with reference to the accompanying drawings, in which various embodiments are shown. However, many different embodiments may be used, and thus the description should not be construed as limited to the embodiments set forth herein. Rather, these embodiments are provided so that this disclosure will be thorough and complete. Like numbers refer to like elements throughout, and prime notation is used to indicate similar elements or steps in alternative embodiments.

In accordance with an example embodiment, a near-field communication (NFC) input device may include an NFC mouse pad to be coupled to an electronic device. The NFC mouse pad may include a first NFC device. The NFC input device may further include an NFC mouse configured to generate movement data based upon movement relative to the NFC mouse pad. The NFC mouse may include a second NFC device to wirelessly communicate the movement data to the first NFC device for the electronic device.

The first NFC device may be configured to provide power via the second NFC device for the NFC mouse. The NFC mouse may further include a mouse housing, and an optical sensing circuit carried by the mouse housing and coupled to the second NFC device. The optical sensing circuit may be configured to generate the movement data, for example.

The first NFC device may include a first NFC antenna and a first NFC transceiver coupled thereto, for example. The second NFC device may include a second NFC antenna and a second NFC transceiver coupled thereto.

The NFC mouse pad may include a free-standing substrate, for example. The first NFC device may be carried by the free-standing substrate.

The NFC mouse pad may include a substrate defining a panel of a case for the electronic device, for example. The first NFC device may be carried by the substrate.

A method aspect is directed to a method of providing input to an electronic device. The method may include coupling the electronic device to a near-field communication (NFC) mouse pad include a first NFC device. The method may further include moving an NFC mouse relative to the NFC mouse pad to generate movement data based upon the movement, and wirelessly communicate the movement data to the first NFC device for the electronic device via a second NFC device of the NFC mouse, for example.

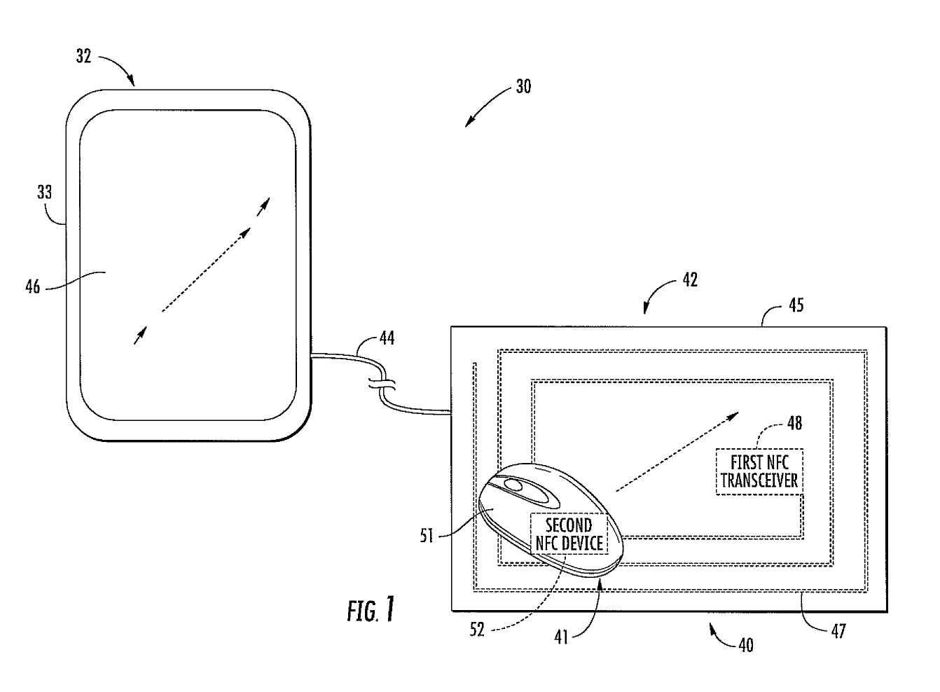

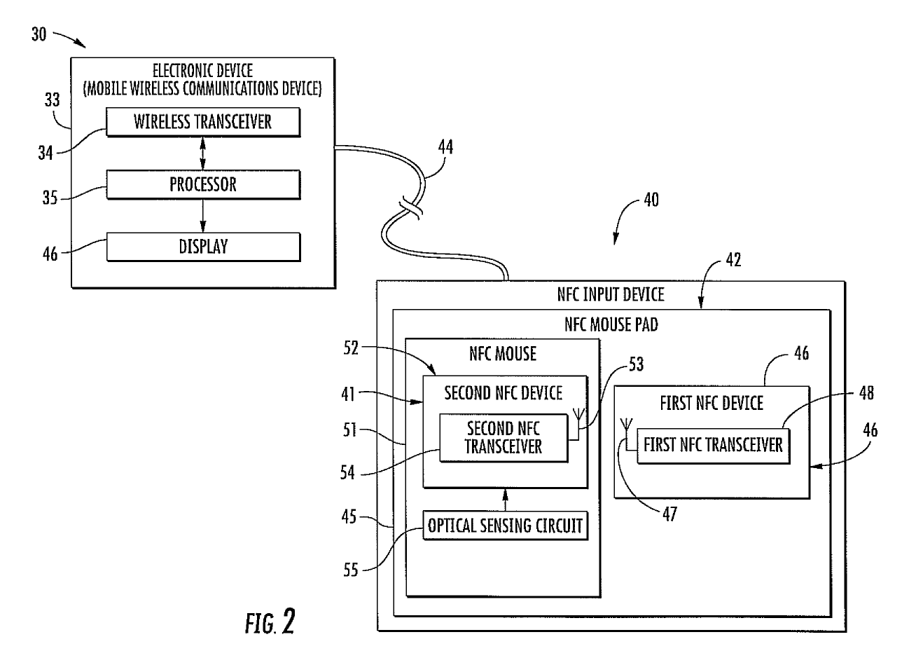

Referring initially to FIGS. 1-2, a near-field communications system 30 includes an electronic device 32 illustratively in the form of a mobile wireless communications device (also referred to a “mobile device” hereinafter). Example electronic devices may include a personal computer, tablet computer, gaming system, or other electronic device, which may or may not be portable or wireless. The mobile wireless communications device 32 may include portable or personal media players (e.g., music or MP3 players, video players, etc.), portable gaming devices, portable or mobile telephones, smartphones, tablet computers, digital cameras, etc.

The electronic device 32 illustratively includes a portable or device housing 33. A wireless transceiver 34 is also carried by the portable housing 33. The wireless transceiver 34 may comprise a cellular transceiver, wireless local area network (WLAN) transceiver, or other type of wireless communications transceiver, and may communicate any combination of voice and data, such as, for example, email.

The electronic device 32 includes a display 46 carried by the portable housing 33. The display 46 may comprise a liquid crystal display (LCD) and may be configured to display information relating to data or voice communications. The display 46 may be in the form of an active display that includes a backlight, for example. The display 46 may display email information, contact information, call information, or information from a website or application. The display 46 may be another type of display, for example, a passive display, and may display other information.

The electronic device 32 also includes a processor 35 that is carried by the portable housing 33 and coupled to the wireless transceiver 34 and the display 46. The processor 35 may be implemented using hardware (e.g., memory, etc.) and software components, i.e., computer-readable instructions for causing the electronic device 32 to perform the various functions or operations described herein.

The NFC input device 40 that includes an NFC mouse 41 and a NFC mouse pad 42 is coupled to the electronic device 32. More particularly, the NFC input mouse pad 42 is coupled via a wired interface, for example, via a micro universal serial bus (USS) interface 44. Of course, the NFC mouse pad 42 may be coupled to the mobile device 32 via another type of wired interface. In some embodiments, the NFC input mouse pad 42 may be coupled to the electronic device 32 via a wireless interface.

The NFC mouse pad 42 includes a freestanding substrate 45. The freestanding substrate 45 may be a rubber or plastic substrate, for example, and may be flexible. Of course, in other embodiments, the substrate 45 may be rigid.

A first NFC device 46 is carried by the freestanding substrate 45. The first NFC device 46 includes a first NFC antenna 47 and a first NFC transceiver 48 coupled to the first NFC antenna. The first NFC antenna 47 and the first NFC transceiver 48 may be embedded within the freestanding substrate 45, for example, so that it is not visible to a user. However, in some embodiments, the first NFC antenna 47 may be carried by an exterior surface of the freestanding substrate 45.

The first NFC antenna 47 is sized to correspond to the size of the freestanding substrate 45. More particularly, the first NFC antenna 47 may extend along a periphery of the freestanding substrate 45. For example, in some embodiments, the first NFC antenna 47 may be spirally wound (e.g., five-times) around an outermost one-inch perimeter of the freestanding substrate 45. Of course, more than one first NFC antenna may be carried by the freestanding substrate 45 and coupled to the first NFC transceiver 48.

By way of background, NFC is a short-range wireless communications technology in which NFC-enabled devices are “swiped,” “bumped” or otherwise moved in close proximity to communicate. In one non-limiting example implementation, NFC may operate at 13.56 MHz and with an effective range of about 10 cm, but other suitable versions of near-field communication which may have different operating frequencies, effective ranges, etc., for example, may also be used.

The NFC mouse 41 includes a mouse housing 51 and a second NFC device 52 carried by the mouse housing. The second NFC device 52 includes a second NFC antenna 53 and a second NFC transceiver 54 coupled to the second NFC antenna. An optical sensing circuit 55 is also carried by the mouse housing 51. The optical sensing circuit 55 is coupled to the second NFC device 52 and generates movement data for the electronic device 32, for example, moving a cursor, or other input. For example, the optical sensing circuit 55 may include optical sensors, photodiodes, light emitting diodes, lasers, and other components that may typically be found in an optical or laser mouse, as will be appreciated by those skilled in the art. In some embodiments, the NFC mouse 41 may not include an optical sensing circuit, but rather a mechanical sensing circuit, for example, a tracking ball, to generate the movement data.

The movement data is based upon movement of the NFC mouse 41 relative to the NFC mouse pad 42. The second NFC device 52 wirelessly communicates, via cooperation between the second NFC antenna 53 and the second NFC transceiver 54, the movement data to the first NFC device 46, i.e., NFC mouse pad 42, for the electronic device 32. Of course, more than one second NFC antenna 53 may be carried by the mouse housing 51 and coupled to the second NFC transceiver 54.

In some embodiments, the first NFC device 46 advantageously provides power via the second NFC device 52. In other words, the NFC mouse 41 operates without batteries, for example, as its power or energy is harvested from the first NFC device 46. This may be particularly advantageous for reducing battery waste and decreasing overall operating costs. Additionally, by not having any batteries, the NFC mouse 41 may have a reduced size, which may be particularly advantageous in portable applications.

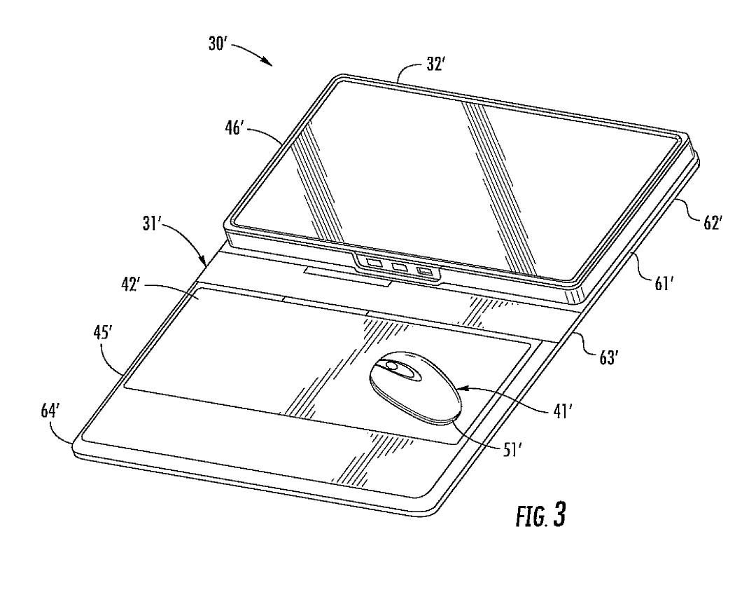

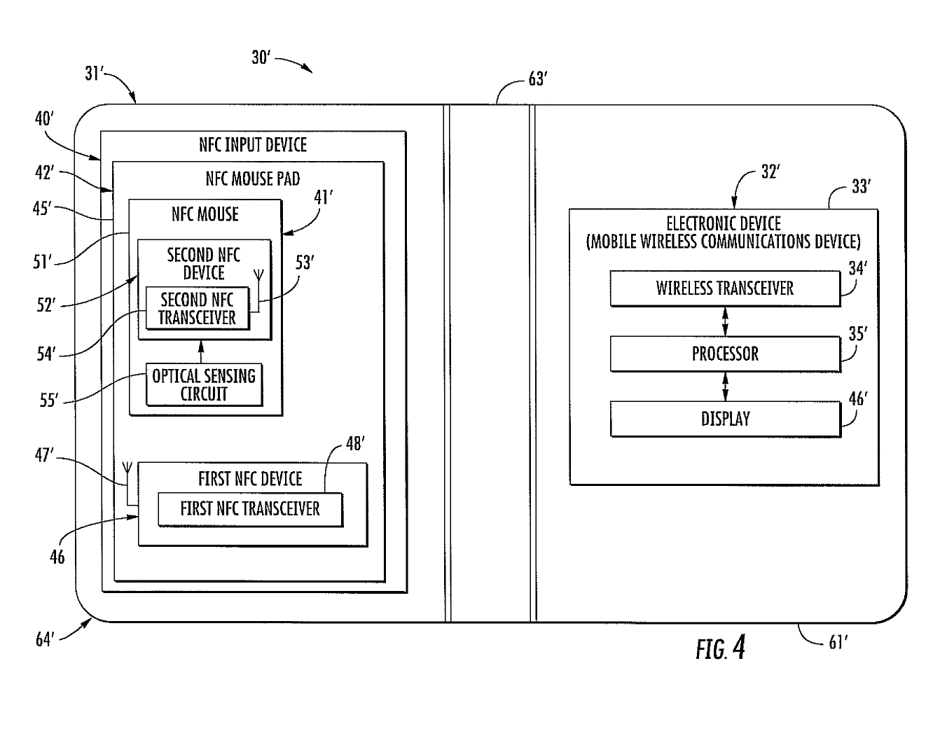

Referring now to FIGS. 3 and 4, in another example embodiment, a carrying case 31′ may carry the mobile device 32′. The carrying case 31′ is an accessory configured to carry the electronic device 32′. For example, the carrying case 31′ may be a protective case as will be described in further detail below.

The carrying case 31′ is illustratively a flip-type carrying case that includes a base panel 61′. A frame 62′ extends outwardly from the base panel 61′. The electronic device 32′ is carried within the frame 62′. The frame 62′ may provide increased protection for the electronic device 32′ while being carried. In some embodiments, the carrying case 31′ may not include a frame 62′.

A hinge panel 63′ couples the base panel to a removable cover panel 64′ or lid. More particularly, the hinge panel 63′ advantageously permits the removable cover panel 64′ to be moved to cover the display 46′ of the electronic device 32′. The removable cover panel 64′ may provide increased protection from damage or wear and tear, for example, while be carried, but not in use.

As will be appreciated by those skilled in the art, the removable cover panel 64′ may be removed to expose the display 46′ of the electronic device 32′ during use. Of course, the removable cover panel 64′ may cover other parts of the electronic device 32′. Additionally, in some embodiments, the removable cover panel 64′ may include cover hinge panels so that it may be folded to a reduced size, for example, and may support the carrying case 31′ while in use.

The removable cover panel 64′ may include a substrate 45′ that is part of the NFC mouse pad 42′. The first NFC device 46′, including the first NFC antenna 47′ and first NFC transceiver 48′ may be embedded within the substrate 45′ of the removable cover panel 64′. The NFC mouse 41′ may be moved over or relative to the removable cover panel 64′ to generate the movement data.

While the NFC mouse pad 42′ described above is part of the removable cover panel 64′, it should be understood that the NFC mouse pad may be included within other parts of the carrying case 31′. For example, the NFC mouse pad 42′ may be part of an extension panel that folds or extends from any of the base panel 61′, the removable cover panel 64′, and the hinge panel 63′.

A method aspect is directed to a method of providing input to an electronic device 32. The method includes coupling the electronic device 32 to a near-field communication (NFC) mouse pad 42 that includes a first NFC device 46. The method also includes moving an NFC mouse 41 relative to the NFC mouse pad 42 to generate movement data. The method also includes moving the NFC mouse 41 relative to the NFC mouse pad 42 to wirelessly communicate the movement data to the first NFC device 46 for the electronic device 32 via a second NFC device 52 of the NFC mouse 41.

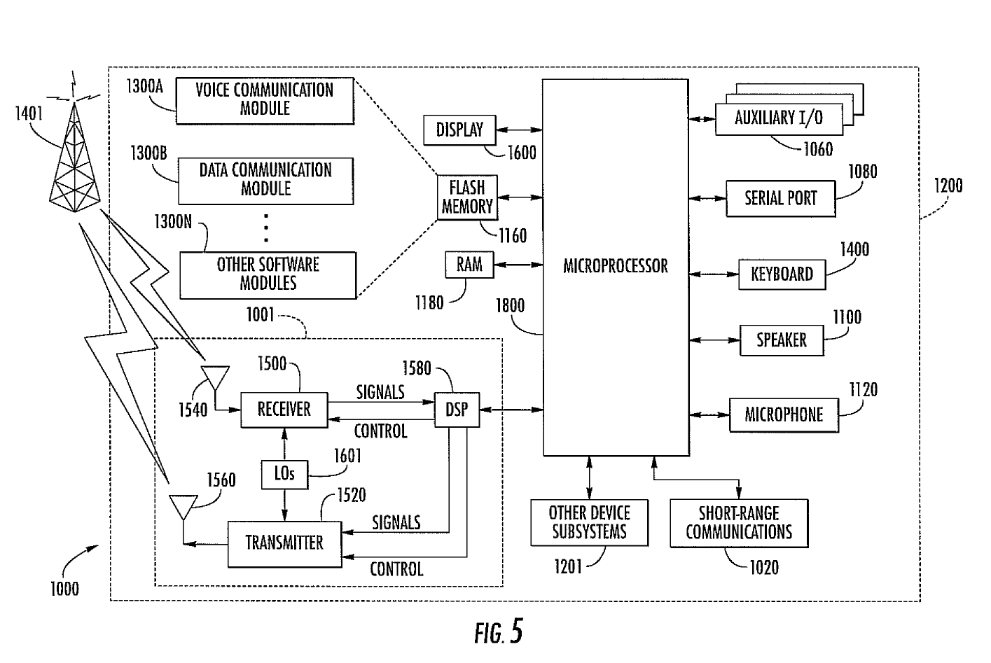

Exemplary components that may be used in various embodiments of the above-described mobile wireless communications device are now described with reference to an exemplary electronic device 1000 shown in FIG. 5. The device 1000 illustratively includes a housing 1200, a keypad 1400 and an output device 1600. The output device shown is a display 1600, which may comprise a full graphic LCD. In some embodiments, display 1600 may comprise a touch-sensitive input and output device. Other types of output devices may alternatively be utilized. A processing device 1800 is contained within the housing 1200 and is coupled between the keypad 1400 and the display 1600. The processing device 1800 controls the operation of the display 1600, as well as the overall operation of the electronic device 1000, in response to actuation of keys on the keypad 1400 by the user. In some embodiments, keypad 1400 may comprise a physical keypad or a virtual keypad (e.g., using a touch-sensitive interface) or both.

The housing 1200 may be elongated vertically, or may take on other sizes and shapes (including clamshell housing structures, for example). The keypad 1400 may include a mode selection key, or other hardware or software for switching between text entry and telephony entry.

In addition to the processing device 1800, other parts of the electronic device 1000 are shown schematically in FIG. 5. These include a communications subsystem 1001; a short-range communications subsystem 1020; the keypad 1400 and the display 1600, along with other input/output devices 1060, 1080, 1100 and 1120; as well as memory devices 1160, 1180 and various other device subsystems 1201. The electronic device 1000 may comprise a two-way RF communications device having voice and data communications capabilities. In addition, the electronic device 1000 may have the capability to communicate with other computer systems via the Internet.

Operating system software executed by the processing device 1800 may be stored in a persistent store, such as the flash memory 1160, but may be stored in other types of memory devices, such as a read only memory (ROM) or similar storage element. In addition, system software, specific device applications, or parts thereof, may be temporarily loaded into a volatile store, such as the random access memory (RAM) 1180. Communications signals received by the mobile device may also be stored in the RAM 1180.

The processing device 1800, in addition to its operating system functions, enables execution of software applications or modules 1300A-1300N on the device 1000, such as software modules for performing various steps or operations. A predetermined set of applications that control basic device operations, such as data and voice communications 1300A and 1300B, may be installed on the device 1000 during manufacture. In addition, a personal information manager (PIM) application may be installed during manufacture. The PIM may be capable of organizing and managing data items, such as e-mail, calendar events, voice mails, appointments, and task items. The PIM application may also be capable of sending and receiving data items via a wireless network 1401. The PIM data items may be seamlessly integrated, synchronized and updated via the wireless network 1401 with the device user's corresponding data items stored or associated with a host computer system.

Communication functions, including data and voice communications, are performed through the communications subsystem 1001, and possibly through the short-range communications subsystem. The communications subsystem 1001 includes a receiver 1500, a transmitter 1520, and one or more antennas 1540 and 1560. In addition, the communications subsystem 1001 also includes a processing module, such as a digital signal processor (DSP) 1580, and local oscillators (LOs) 1601. The specific design and implementation of the communications subsystem 1001 is dependent upon the communications network in which the electronic device 1000 is intended to operate. For example, a electronic device 1000 may include a communications subsystem 1001 designed to operate with the Mobitex™, Data TAC™ or General Packet Radio Service (GPRS) mobile data communications networks, and also designed to operate with any of a variety of voice communications networks, such as AMPS, TDMA, CDMA, WCDMA, PCS, GSM, EDGE, etc. Other types of data and voice networks, both separate and integrated, may also be utilized with the electronic device 1000. The electronic device 1000 may also be compliant with other communications standards such as GSM, 3G, UMTS, 4G, etc.

Network access requirements vary depending upon the type of communication system. For example, in the Mobitex and DataTAC networks, mobile devices are registered on the network using a unique personal identification number or PIN associated with each device. In GPRS networks, however, network access is associated with a subscriber or user of a device. A GPRS device therefore utilizes a subscriber identity module, commonly referred to as a SIM card, in order to operate on a GPRS network.

When required network registration or activation procedures have been completed, the electronic device 1000 may send and receive communications signals over the communication network 1401. Signals received from the communications network 1401 by the antenna 1540 are routed to the receiver 1500, which provides for signal amplification, frequency down conversion, filtering, channel selection, etc., and may also provide analog to digital conversion. Analog-to-digital conversion of the received signal allows the DSP 1580 to perform more complex communications functions, such as demodulation and decoding. In a similar manner, signals to be transmitted to the network 1401 are processed (e.g. modulated and encoded) by the DSP 1580 and are then provided to the transmitter 1520 for digital to analog conversion, frequency up conversion, filtering, amplification and transmission to the communication network 1401 (or networks) via the antenna 1560.

In addition to processing communications signals, the DSP 1580 provides for control of the receiver 1500 and the transmitter 1520. For example, gains applied to communications signals in the receiver 1500 and transmitter 1520 may be adaptively controlled through automatic gain control algorithms implemented in the DSP 1580.

In a data communications mode, a received signal, such as a text message or web page download, is processed by the communications subsystem 1001 and is input to the processing device 1800. The received signal is then further processed by the processing device 1800 for an output to the display 1600, or alternatively to some other auxiliary I/O device 1060. A device user may also compose data items, such as e-mail messages, using the keypad 1400 and/or some other auxiliary I/O device 1060, such as a touchpad, a rocker switch, a thumb-wheel, or some other type of input device. The composed data items may then be transmitted over the communications network 1401 via the communications subsystem 1001.

In a voice communications mode, overall operation of the device is substantially similar to the data communications mode, except that received signals are output to a speaker 1100, and signals for transmission are generated by a microphone 1120. Alternative voice or audio I/O subsystems, such as a voice message recording subsystem, may also be implemented on the device 1000. In addition, the display 1600 may also be utilized in voice communications mode, for example to display the identity of a calling party, the duration of a voice call, or other voice call related information.

The short-range communications subsystem enables communication between the electronic device 1000 and other proximate systems or devices, which need not necessarily be similar devices. For example, the short-range communications subsystem 1020 may include an infrared device and associated circuits and components, near-field communication (NFC), or a Bluetooth™ communications module to provide for communication with similarly-enabled systems and devices.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A near-field communication (NFC) input device comprising:
an NFC mouse pad to be coupled to an electronic device and comprising a first NFC device; and
an NFC mouse configured to generate movement data based upon movement relative to said NFC mouse pad, and comprising a second NFC device to wirelessly communicate the movement data to said first NFC device for the electronic device.

2. The NFC input device of claim 1, wherein said first NFC device is configured to provide power via said second NFC device for said NFC mouse.

3. The NFC input device of claim 1, wherein said NFC mouse further comprises:
a mouse housing; and
an optical sensing circuit carried by said mouse housing, and coupled to said second NFC device, and configured to generate the movement data.

4. The NFC input device of claim 1, wherein said first NFC device comprises a first NFC antenna and a first NFC transceiver coupled thereto.

5. The NFC input device of claim 1, wherein said second NFC device comprises a second NFC antenna and a second NFC transceiver coupled thereto.

6. The NFC input device of claim 1, wherein said NFC mouse pad comprises a free-standing substrate; and wherein said first NFC device is carried by said free-standing substrate.

7. The NFC input device of claim 1, wherein said NFC mouse pad comprises a substrate defining a panel of a case for the electronic device; and wherein said first NFC device is carried by said substrate.

8. A near-field communication (NFC) system comprising:
an electronic device comprising a device housing and a processor carried by said device housing;
an NFC mouse pad coupled to said electronic device and comprising a first NFC device; and
an NFC mouse configured to generate movement data based upon movement relative to said NFC mouse pad, and comprising a second NFC device to wirelessly communicate the movement data to said first NFC device for the electronic device.

9. The NFC system of claim 8, wherein said first NFC device is configured to provide power via said second NFC device for said NFC mouse.

10. The NFC system of claim 8, wherein said NFC mouse further comprises:
a mouse housing; and
an optical sensing circuit carried by said mouse housing, and coupled to said second NFC device, and configured to generate the movement data.

11. The NFC system of claim 8, wherein said first NFC device comprises a first NFC antenna and a first NFC transceiver coupled thereto.

12. The NFC system of claim 8, wherein said second NFC device comprises a second NFC antenna and a second NFC transceiver coupled thereto.

13. The NFC system of claim 8, wherein said NFC mouse pad comprises a free-standing substrate; and wherein said first NFC device is carried by said free-standing substrate.

14. The NFC system of claim 8, wherein said NFC mouse pad comprises a substrate defining a panel of a case for the electronic device; and wherein said first NFC device is carried by said substrate.

15. A method of providing input to an electronic device comprising:
coupling the electronic device to a near-field communication (NFC) mouse pad comprising a first NFC device;
moving an NFC mouse relative to the NFC mouse pad to
generate movement data based upon the movement relative to the NFC mouse pad, and
wirelessly communicate the movement data to the first NFC device for the electronic device via a second NFC device of the NFC mouse.

16. The method of claim 15, wherein the first NFC device provides power via the second NFC device for the NFC mouse.

17. The method of claim 15, wherein the NFC mouse further comprises:
a mouse housing; and
an optical sensing circuit carried by the mouse housing, coupled to the second NFC device for generating the movement data.

18. The method of claim 15, wherein the first NFC device comprises a first NFC antenna and a first NFC transceiver coupled thereto.

19. The method of claim 15, wherein the second NFC device comprises a second NFC antenna and a second NFC transceiver coupled thereto.

20. The method of claim 15, wherein the NFC mouse pad comprises a free-standing substrate; and wherein the first NFC device is carried by the free-standing substrate.

21. The method of claim 15, wherein the NFC mouse pad comprises a substrate defining panel of a case for the electronic device; and wherein the first NFC device is carried by the substrate.
